(19) United States
(12) Patent Application Publication
(10) Pub. No.: US 2013/0331590 A1
(43) Pub. Date: Dec. 12, 2013

(54) Apparatus and Method for Manufacturing Permanently Confined Micelle Array Nanoparticles

(71) Applicants: William A. Farone, Irvine, CA (US); Shane L. Palmer, Colo de Caza, CA (US); Miguel A. Rivers, Orange, CA (US); Christian Taylor, Garden Grove, CA (US)

(72) Inventors: William A. Farone, Irvine, CA (US); Shane L. Palmer, Colo de Caza, CA (US); Miguel A. Rivers, Orange, CA (US); Christian Taylor, Garden Grove, CA (US)

(21) Appl. No.: 13/833,083

(22) Filed: Mar. 15, 2013

Related U.S. Application Data
(60) Provisional application No. 61/657,737, filed on Jun. 8, 2012.

(51) Int. Cl. B01J 20/30; B01J 19/00

(52) U.S. Cl. CPC B01J 20/30; B01J 19/0066
USPC 556/9; 556/425; 422/225

(57) ABSTRACT

A cylindrical reactor has walls and a base, forming a chamber in which permanently manufactured micelle array nanoparticles may be manufactured. The reactor has a disk impeller inside the chamber which serves to mix reagents in the chamber and a collar which facilitates the mixing process. The reactor is effective to input an amount of energy to the mixed reagents such that particle coagulation is prevented but formation of PCMA nanoparticles is permitted. A method for manufacturing PCMA nanoparticles is disclosed. Reagents, beginning with prepared core particles, are stepwise added to a reactor and mixed. A high sheer mixing unit is used to input an amount of energy to the mixed reagents such that particle coagulation is prevented but formation of PCMA nanoparticles is permitted.

### CROSS REFERENCE TO RELATED APPLICATIONS

The present invention claims priority under 35 U.S.C. §119(e) of U.S. Provisional Patent Application No. 61/657,737, filed Jun. 8, 2012, entitled “Apparatus and Method for Manufacturing Permanently Confined Micelle Array Nanoparticles” the contents of which are incorporated herein by reference in their entirety.

### FIELD OF THE DISCLOSURE

The subject matter of the present disclosure generally relates to nanoparticles, and more particularly to the manufacture of Permanently Confined Micelle Array (PMCA) nanoparticles.

### BACKGROUND OF THE DISCLOSURE

The use of nanoparticles for absorbing target chemicals from air, water and other solvents has been previously disclosed. PCMA nanoparticles can be used in this respect. PCMA nanoparticles have a ligand or “attachment” chemical confined inside the particle's porous (or amorphous) structure such that the removal of the target chemical from a solution is enhanced. Absorption of target chemicals is particularly effective with PCMA nanoparticles in part because of their relatively large surface area resulting from their small size.

Unfortunately, the small size of PCMA nanoparticles leads to a number of problems in their efficient manufacture. Previously disclosed preparation methods are slow, energy intensive, and use large quantities of solvents that create excessive wastes. Thus, these methods are generally suitable for small-scale laboratories but not commercial-scale needs.

An exemplary previously-disclosed technique using a Fe₃O₄ core follows. First, 0.1 g of Fe₂O₃ (Aesar Maghemite) is measured into a centrifuge tube. Next, 40 mL of tetramethyl ammonium hydroxide (TMAOH) is added to the tube. A roller is used for a minimum of 12 hours to negatively charge the particles in the mixture. The TMAOH is decanted off into another container. Next, 25 mL of ethanol is added to the mixture, which is then shaken or put on a vortex for 2 minutes. Then a large magnet is used to recover the iron oxide at the bottom of the tube and the supernatant is poured off. Ethanol is added to the mixture and the process of shaking, using a magnet, and pouring off the supernatant is repeated three times. Next, 40 mL of ethanol is added to the tube. Together these steps are the process for surface activation of the core magnetic nanoparticle, the result of which is a stock solution. Next, functionalization of the core magnetic particles with tetraethylorthosilicate (TEOS) and 3-(trimethoxysily)propyl-octadecyldimethyl-ammonium chloride (TPODAC) is performed.

First, 287.5 mL of ethanol and 50.0 mL of nanopure water are added into a 500 mL bottle. The stock solution is vortexed for 1 minute, after which 12.5 mL of the stock solution is added to the 500 mL bottle via a pipette. The resulting mixture is spun for 5 minutes. Then, 1.2 mL of TPODAC is drop-wise added to the spinning mixture and spun for an additional 20 minutes. The mixture is then sonicated for 20 minutes. Next, 5 mL of a 28% solution of NH₃ in water is added to the mixture and it is spun for 2 minutes. Next, 1.10 mL of TEOS is added to the mixture, which is then spun for 2 hours. The 500 mL bottle is then placed on a large magnet and the iron oxide PCMAs are allowed to settle to the bottom of the bottle. The supernatant is decanted off while the magnet is applied to the bottom of the bottle. The resulting particles are then rinsed with ethanol and transferred to a 50 mL centrifuge tube. The particles are rinsed 3 more times using a magnet to isolate the particles while the liquid is decanted between repetitions. The final resulting particles are allowed to dry.

Altogether, the above technique produces approximately 200 mg of finished particles while resulting in 750 ml of wasted solvents and reagents. It therefore produces 3,750 liters of waste for each kilogram of PCMA particles. Thus, while the process does produce PCMA nanoparticles, it is impractical and not commercially viable.

Process scalability is a frequent challenge in chemical engineering applications. It is difficult to maintain sufficient mixing during the PCMA nanoparticle production process when up-scaling the process batch size. The inability of the exemplary previously-disclosed process to be scaled also hinders its use in production at commercial levels.

The subject matter of the present disclosure is directed to overcoming, or at least reducing the effects of, one or more of the problems set forth above.

### BRIEF SUMMARY OF THE DISCLOSURE

Disclosed are a reactor apparatus for, and a method of, manufacturing PCMA nanoparticles. As discussed above, such nanoparticles are useful in the collection of target chemicals, and so are suitable for reclamation and environmental cleanup activities.

A cylindrical reactor has a vertical wall attached to a base. A high sheer mixing unit, which can be integral with, or attached to, the reactor has a shaft connected to a disk impeller. The disk impeller is used to mix reagents during the PCMA nanoparticle production process. A collar located within the reactor and surrounding the disk impeller facilitates the mixing process. The geometry of these elements and the selection of a particular range of disk impeller tip speed ensure that the mixing reagents are supplied with enough energy so that the core particles do not impermissibly coagulate during the production process but not so much energy that the other chemicals of the reaction are unable to produce the desired surface coating on the core particles due to the other chemicals of the reaction reacting with themselves in the bulk solution rather than with the coating being formed on the surface of the particles.

The disclosed method begins with a reactor having a reaction chamber and high sheer mixing unit. Prepared core particles are mixed with a reaction solvent in the reactor. Then, ligand, a solution of ammonia in water and finally an amount of TEOS is are stepwise added to the reactor, after which the mixture of reagents is mixed using the high sheer mixing unit so as to prevent particle coagulation during the reaction process but allow surface coatings to develop on the core particles.

The disclosed apparatus and method present several significant advantages. First, the amount of waste produced alongside the production of PCMA nanoparticles is reduced. Also, the apparatus and method are highly scalable, so that batch size can be increased significantly while simultaneously maintaining particle efficacy. Both of these characteristics make the disclosure well suited for the large scale or commercial production of PCMA nanoparticles.

The details of one or more embodiments of the invention are set forth in the accompanying drawings and descriptions below. The foregoing summary is not intended to summarize each potential embodiment or every aspect of the disclosure.

### BRIEF DESCRIPTION OF THE DRAWINGS

FIG. 1 is a cut-away depiction of an illustrative embodiment of the disclosed reactor.

FIG. 2 is a top view diagram of the interior of an exemplary embodiment of the disclosed reactor.

FIG. 3 is a side view cutaway diagram of the reactor embodiment of FIG. 2.

FIG. 4 is an enhanced side view of the disk impeller of the reactor embodiment of FIG. 2.

FIG. 5 is a flow chart diagram of an embodiment of the disclosed PCMA nanoparticle manufacturing method.

FIG. 6 is a flow chart diagram of the method embodiment of FIG. 5, also showing the ethanol washing of manufactured particles and their subsequent drying.

### DETAILED DESCRIPTION OF THE DISCLOSURE

Disclosed is a reactor for, and method of, manufacturing PCMA nanoparticles. There are a variety of suitable core particles upon which a PCMA coating can be applied. Generally, any spherical particle with a diameter of 100 to 40,000 nm is suitable. Metal oxide particles such as Fe₃O₄, SiO₂, SiO₂.X H₂O, TiO₂ and Al₂O₃ are suitable because the surface of these particles can easily accept silicate coating. Embodiments of the present disclosure are discussed in the context of an exemplary reaction utilizing Fe₃O₄, TiO₂ and SiO₂ as core particles and TPODAC as a ligand. However, various other core particles and ligands can be produced by the disclosed apparatus and method by simple substitution. For instance, ligands other than TPODAC can be incorporated in the PCMA coating by replacing TPODAC with another substance during the manufacturing process.

It is challenging to effectively mix reagents during the production of PCMA nanoparticles so as to prevent particle coagulation while simultaneously allowing the other reagents to form a PCMA coating on the core particles. The ability to maintain an effective degree of mixing in the manufacturing process and the ability to up-scale that process are significantly influenced by the application of energy (power over a period time) into the volume of liquid that contains the reagents. For PCMA nanoparticle manufacturing, the energy input into the fluid must be high enough to keep the core particles in suspension and prevent coagulation as the surface coating on these particles grows. However, the energy input must not be so high so as to interfere with the coating of the core particles by the other chemicals in the fluid. If the fluid is kept from the particles the chemicals in the solution will nucleate and form small independent particles (homogeneous nucleation and growth) rather than grow on the existing particles (heterogeneous growth). Chemical manufacturing is, in general, complicated by the fact that the power consumed by a motor agitating a reagent mixture is not directly related to the mixing that occurs. Often, individuals in the field must rely on empirical studies and correlations to effectuate up-scaling.

The disclosed apparatus and method utilize high shear mixing as a mechanism by which to input sufficient energy to the mixing fluids in a reactor. “Volumetric energy input” is defined as the amount of energy input per unit volume of liquid over the time of the reaction. Volumetric energy input could optionally be expressed in terms of Joule-hours for reactions lasting several hours. The “energy” described is not the power consumed by the agitator over the time of the reaction but the energy input into the fluid to keep it moving in a turbulent fluid flow field. The amount of volumetric energy input to the mixture by the disclosed reactor or during the disclosed method is the amount of energy required to keep the fluid moving so particles do not coagulate but also so that the growth of the surface coatings is not prevented. A reactor with a disk impeller is suitable for this methodology due to its ability to transfer the same amount of energy to a fluid even as the reactor and disk are scaled up.

One parameter of the disclosed reactor is the “tip speed” of the disk impeller. In a number of demonstrated embodiments, 0.3 to 0.4 meters per second was effective for PCMA nanoparticle manufacturing. Assuming that the mechanical losses from the disk impeller is 10% (a typical loss after stable continuous flow) then a liter of fluid weighing about 1 kilogram is moving at 0.27 to 0.36 m/sec. The average fluid velocity of 0.315 m/sec indicates that the reaction requires a sustained energy input of 0.05 J during the course of the process. Therefore, an exemplary 3 hour reaction would require 0.15 Joule-hours of volumetric energy input for each liter in the reactor.

The amount of energy required at a motor to impart an amount of volumetric energy input to a fluid in a reactor will differ depending on the design of the disk impeller and the reactor. For example, if the system was frictionless less energy at the motor would be needed to maintain the volumetric energy input after the reactor was operating continuously. By defining the volumetric energy input on a per liter basis, the amount of volumetric energy input for a given system is that value times the fluid volume.

Resultant PCMA nanoparticles can be stored wet or dry, though wet storage can be safer because the particles are thereby prevented from dusting. Nanoparticle efficacy can be tested through the use of a 120 mg/L solution of methyl orange. When 25 mg of the particles are added to 5 ml of the methyl orange solution the color should disappear in 40 minutes or less. Identical particle functionality between previously disclosed methods and the present disclosure can be confirmed with this procedure.

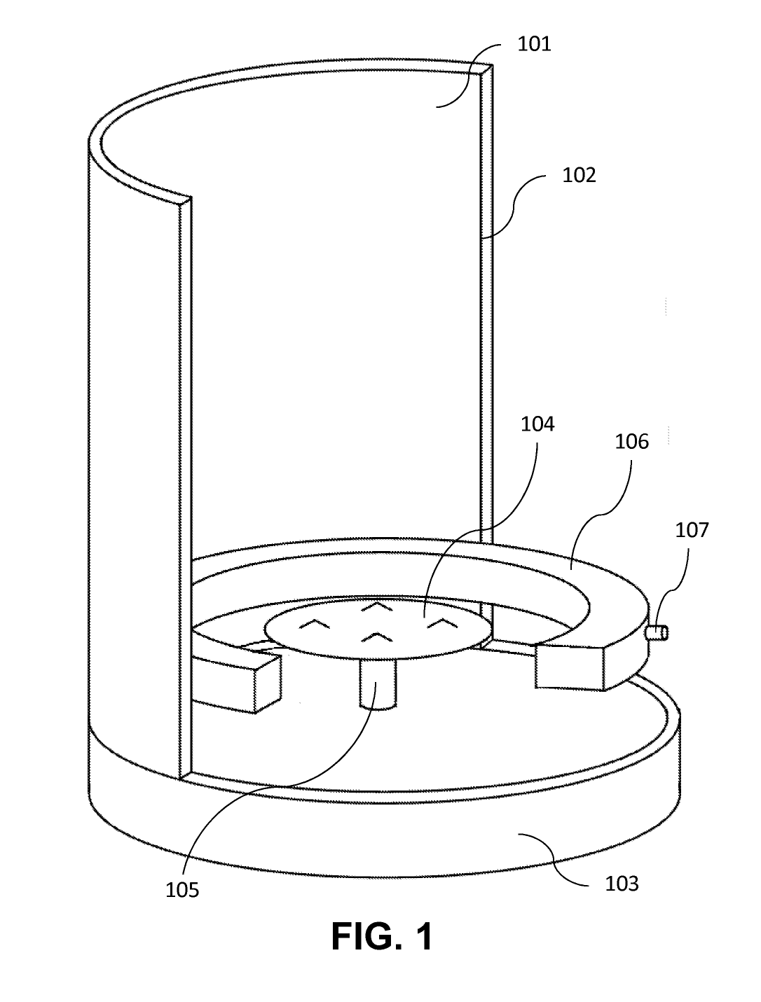

FIG. 1 is a cut-away view of an illustrative embodiment of the disclosed reactor. Cylindrical reactor 101 has a vertical interior wall 102 joined to base 103. In the illustrative embodiment, base 103 houses a motor. Disk impeller 104 is joined with the motor via shaft 105. Collar 106 is displaced between vertical interior wall 102 and disk impeller 104, and is connected to vertical interior wall 102 via a plurality of posts 107. The vertical axis of reactor 101, disk impeller 104, shaft 105, and collar 106 are all coincidental.

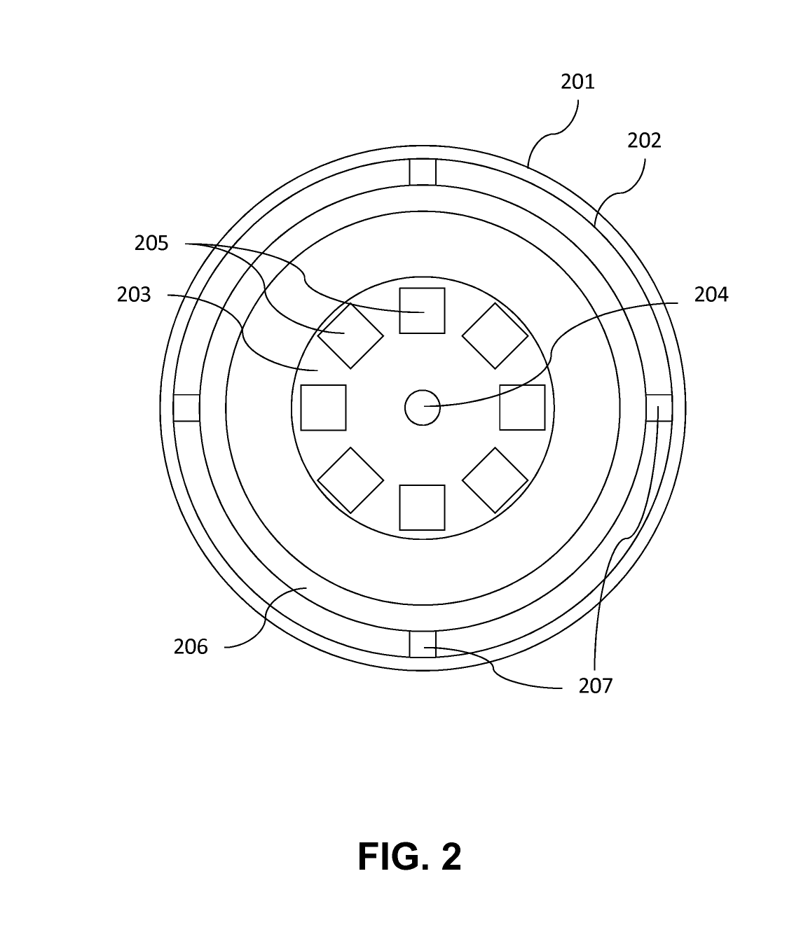

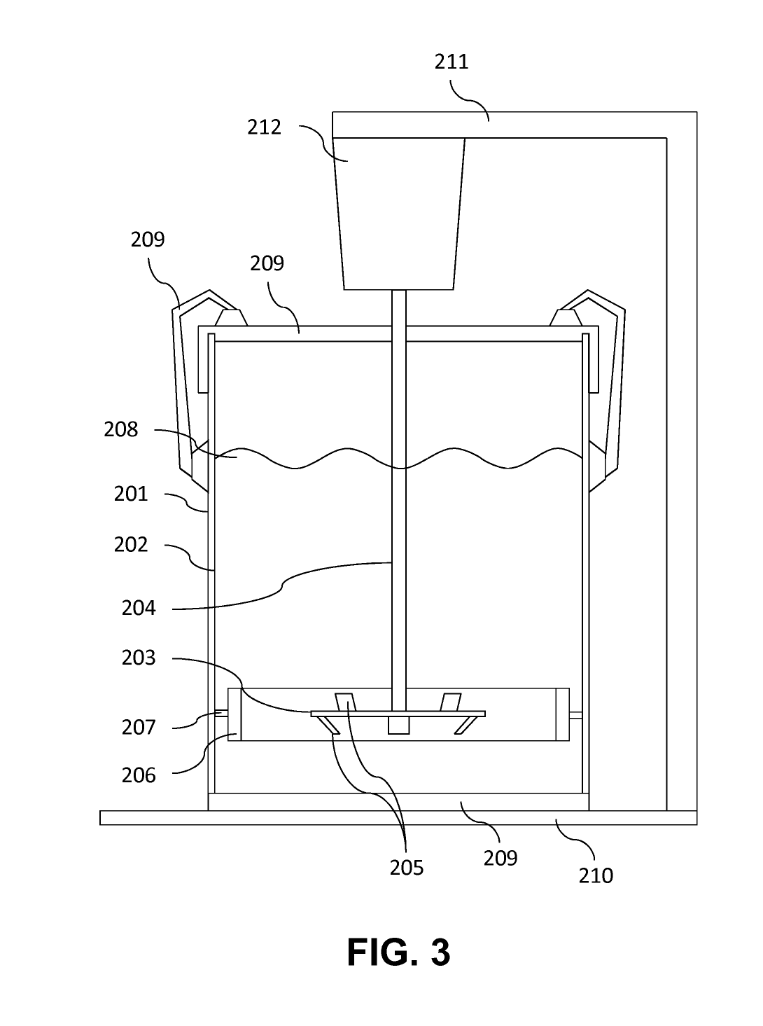

FIG. 2 and FIG. 3 together depict an exemplary embodiment reactor 201. FIG. 2 is a top view diagram of the interior of reactor 201. Reactor 201 has interior wall 202. Disk impeller 203 is attached to a motor (not depicted) via shaft 204. Disk impeller 203 has indent sections 205 spaced evenly around the vertical axis of disk impeller 203 at a radial distance from the vertical axis of disk impeller 203. Collar 206 is displaced between disk impeller 203 and interior wall 202. Posts 207 join collar 206 to interior wall 202. FIG. 3 is a side view diagram of reactor 201 as viewed from a mid-plane of reactor 201. FIG. 3 depicts reactor 201 containing a mixture of reagents 208. There is base 209 to which the wall of the reactor is joined. Stand 210 holds reactor 201 in place. Motor arm 211 suspends motor 212 over reactor 201. Alternatively, motor 212 could be positioned below reactor 201 or within base 209, such that shaft 204 extended into reactor 201 from below. Together motor 212, shaft 204 and disk impeller 203 form a high shear mixing unit. In operation motor 212 spins shaft 204 and thus disk impeller 203 to mix mixture of reagents 208. The geometry of reactor 201, disk impeller 203 and collar 206 are such that, in conjunction with the tip speed of disk impeller 203, the high shear mixing unit inputs an amount of volumetric energy to mixture of reagents 208 sufficient to keep the core particles suspended in mixture of reagents 208 while also allowing other reagents to bond with the core particles to form the desired permanently confined micelle array nanoparticles.

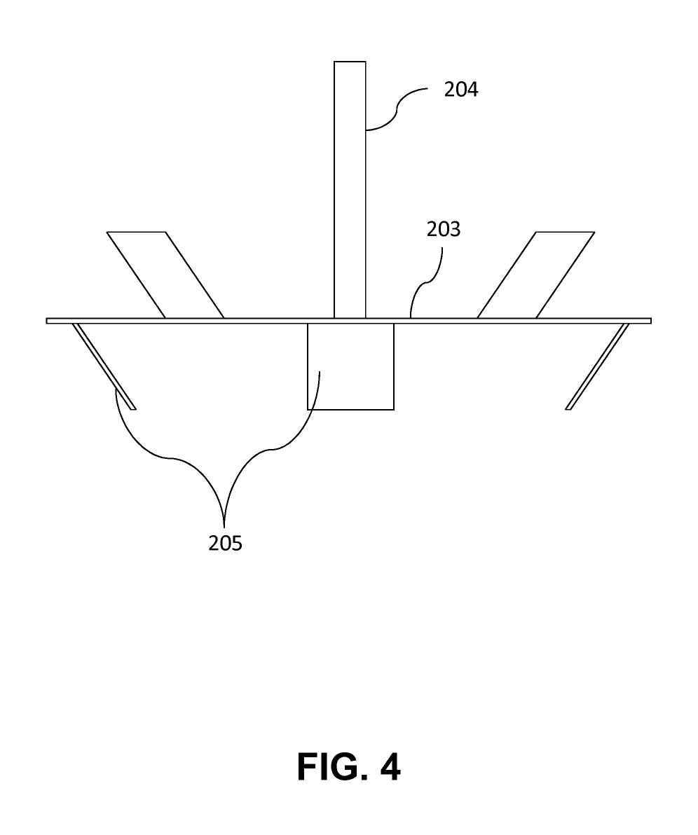

FIG. 4 depicts an enlarged side view of disk impeller 203 and indents 205. In the exemplary embodiment, there are eight indents, which alternate above and below the horizontal mid-plane of disk impeller 203.

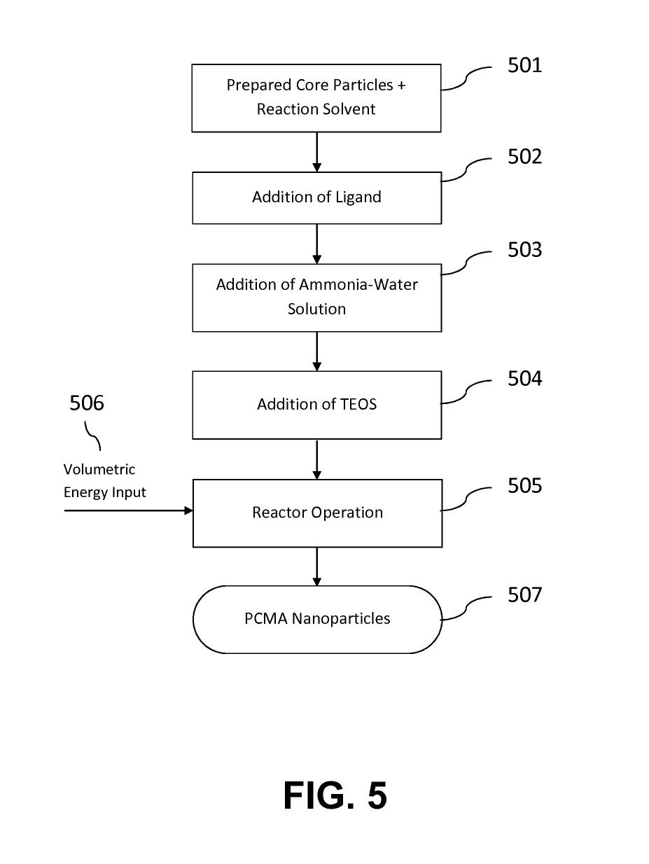

FIG. 5 depicts a flow diagram of an embodiment of the disclosed method of manufacturing nanoparticles. This method is suitable for use with the apparatus depicted in FIGS. 2-4. In step 501, prepared core particles and reaction solvent are added to the reactor and mixed together. In step 502, ligand is added to the reactor and the reagents are mixed. In step 503, a solution of ammonia in water is added to the reactor and the reagents again mixed. Then in step 504, TEOS is added to the reactor. In step 505 the reactor is operated, wherein the high sheer mixing unit inputs volumetric energy input 506. The addition of volumetric energy input 506 to the mixture of reagents results in sufficient shear to keep the core particles suspended in the mixture but also allow the ligand and TEOS to bind to the core particles properly. The operation of the reactor in such a manner produces PCMA nanoparticles 507.

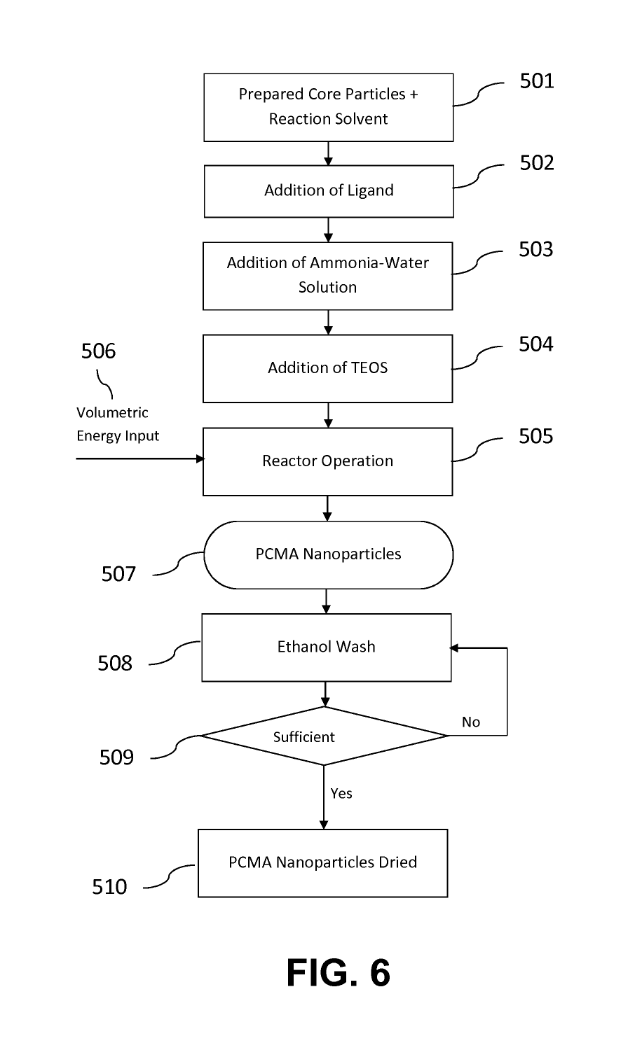

FIG. 6 shows the addition of several steps to the process of FIG. 5. After PCMA nanoparticles 507 are created, they are washed with ethanol in step 508. Step 509 allows that ethanol wash 508 can be repeated if more than one wash is needed. Lastly, the nanoparticles are dried in step 510.

Several demonstrated embodiments of the above described apparatus and method are described below to demonstrate the efficacy and scalability of the disclosed subject matter. The reactor embodiments discussed below correspond generally to the disclosure of FIGS. 2-4. The methods discussed below generally correspond to the disclosure of FIGS. 5-6.

In a first demonstrated embodiment, a reactor is utilized with the disclosed method. The disk impeller of the high shear mixing unit is used at an impeller rate of 1070 rotations per minute (RPM). The reactor has an overall height of 16 cm, a diameter of 12 cm, a height-diameter ratio of 1.33, a radius of 6 cm and a volume of 1.81 liters. The disk impeller is joined to the bottom of a shaft that rises through the top of the lid on the reactor where it is joined to a motor. The disk impeller has a 5.5 cm diameter. There are 8 indents on the impeller disk, which are placed symmetrically around the impeller blade at a radial distance of 1.5 cm from the vertical axis of the disk impeller. The indents are each 1 cm wide and 1 cm long, and alternate up and down by 0.5 cm from the horizontal plane of the impeller disk.

A collar is displaced between the vertical wall of the reactor and the disk impeller. The collar's vertical axis is coincidental with that of the reactor, and its horizontal plane is coincidental with that of the disk impeller. The collar is joined to the vertical wall of the reactor via a number of posts. The collar is 3.5 cm in height, thereby covering both the up and down indents of the disk impeller when the reactor is viewed from the side. The bottom of the collar is displaced 0.3 cm from the base of the reactor. The outside of the collar is 1 cm from the vertical reactor wall. The collar has a radius equivalent to 85% of the distance from the vertical axis of the reactor to the vertical wall of the reactor. This first demonstrated embodiment of the disclosed apparatus is utilized with the following demonstrated embodiment of the method of the disclosure, in which nanoparticles with a Fe₃O₄ core are produced.

The needed reagents are Fe₃O₄ (Alfa Aesar), a solution of TMAOH in water (25%), ethanol (reagent grade, relatively dry, ≦5% water), deionized water, TPODAC (72%), a solution of ammonia in water (28%) and TEOS. As noted before, PCMA nanoparticles can be produced without the use of iron core particles.

Before the reactor is utilized, an initial base containing prepared core particles is developed, beginning with the addition to a 1 L container of 10 g of Fe₃O₄ and 1000 ml of 25% TMAOH. The container is sealed and placed horizontally on a shaker table or similar device and shaken for 18 hours. After shaking, the particles are allowed to settle, or in the case of a magnetic core such as Fe₃O₄, settled through the use of a magnet. The TMOAH solution is then decanted to waste. The particles are washed 3 times with 500 ml of ethanol. During each wash, the particles and ethanol are shaken for 5 minutes after which the ethanol is removed to a separate ethanol waste container. Next, 500 ml of ethanol is added and the mixture shaken. This process prepares enough initial base with prepared core particles for two reactor production cycles.

250 ml of the initial base containing the prepared core particles is placed into the reactor. Next, 1200 ml of ethanol and 200 ml of deionized water are added to the reactor and the resulting mixture is mixed at 1030 rpm for 5 minutes. Then, 12 ml of 72% TPODAC is added to the reactor, the contents of which are then mixed for 10 minutes. Next, 20 ml of a solution of ammonia in water (28%) is added to the reactor, the contents of which are mixed for 5 minutes. Then, 11 ml of TEOS is added to the reactor. The disk impeller is then operated at an impeller rate of 1070 for 3 hours, inputting an amount of volumetric energy into the mixing reagents such that PCMA nanoparticles are created.

In the demonstrated embodiment, the particles are then collected and the supernatant liquid decanted. For magnetic particles, the mixture can be transferred to a non-metallic container and a strong magnet used to collect the particles at the bottom of the container. It may be necessary to use such a magnetic collection system more than once to collect the particles. For non-magnetic particles, a centrifuge or filter can be used. After the supernatant liquid is decanted, the resultant particles are rinsed with approximately 100 ml of fresh ethanol three times. All used supernatant liquid can be placed in a ethanol waste container for subsequent reclamation of the ethanol. The particles are articles dried and ethanol removed by a temperature of 70° C.

For the embodiment batch, 20 grams of PCMA nanoparticles are produced, as well as waste liquids of approximately 3500 ml, 225 ml of which is water. This translates to 175 liters of recoverable waste for each kilogram of resulting product. This is a significant improvement over previously available methods in terms of reagents needed and waste created. Likewise, energy consumption over previously available methods is reduced because sonification and vortexing are unnecessary. Particles produced by this technique were tested for removal of methyl orange. It was found that 5 grams of particles removed 100 mg of methyl orange from 1 liter of water in 5 minutes.

In an alternative embodiment, silica gel is utilized in place of Fe₃O₄ in the disclosed technique and the demonstrated embodiment disk impeller operated at speeds under 1070 RPM. The silica gel particles were tested for the removal of methyl orange and 5 grams of particles removed 100 mg of methyl orange from 1 liter of water in 5 minutes.

In a second demonstrated embodiment, the reactor of the first demonstrated embodiment is scaled up, maintaining the dimensional relationships between the various elements of the apparatus. The scaled up reactor has an overall height of 40.8 cm, a diameter of 30.6 cm, a radius of 15.3 cm and a volume of 15 liters. Thus, the height-diameter ratio remains 1.33. The disk impeller is also scaled, having a diameter of 14 cm. The disk impeller continues to have 8 indents symmetrically placed around the vertical axis of the disk impeller, however these indents are placed at a radial distance of 3.8 cm from the vertical axis of the disk impeller, the indents alternating up and down by 1.3 cm from the horizontal plane of the disk impeller. Each indent is 2.55 cm wide and 2.55 cm long. The scaled up collar has a height of 8.9 can and is displaced 0.8 cm from the base of the reactor. The outside of the collar is 2.4 cm from the vertical reactor wall. The reactor is operated with the disk impeller rotating at a rate of 420 RPM, meaning that the energy transfer to the fluid remains constant with increased impeller size, in part because the tip speed of the disk impeller remains constant between the scaled versions. Utilizing a scaled up version of the process described with the first demonstrated embodiment, 200-600 grams of PCMA nanoparticles can be produced per batch.

In a third demonstrated embodiment, approximately 400 grams of particles based on TiO₂ were produced, starting with 200 grams of TiO₂. An initial amount of 200 grams of TiO₂ was pretreated with a solution of 1.4 liters of TMAOH (25%) mixed with 3 liters of distilled water. The particles are stirred gently in this solution for 20 hours after which time they are removed by the use of a centrifuge and washed with 250 ml aliquots of ethanol twice. The reactor was charged with the particles and 10.8 liters of ethanol plus 1.2 liters of water. The agitator was set for 440 rpm. After 10 minutes 240 ml of TPODAC was added and the mixture stirred for 10 minutes. Next 400 ml of Ammonium Hydroxide was added and the mixture stirred for 10 minutes. Next 240 ml of TEOS was added and the mixture stirred for 6 hours. The particles are then removed by filtration followed by 3 washes of 600 ml of ethanol and allowed to dry at 70° C. after filtration. The weight of particles in one such operation was 384 grams. The particles were tested for the adsorption of methyl orange, 1,1-dichoroethylene and 1,4-dioxane. The particles at 5 grams per liter removed 100 mg of methyl orange in 5 minutes. When used repeatedly for solutions of 1 mg/l of 1,1-dichorethylene mixed with 0.1 mg/l of 1,4-dioxane the chemicals were removed to non-detectible concentrations (less than 0.5 ppb) even after 30 liters of solution had been treated with the same 5 grams of particles.

In a fourth demonstrated embodiment approximately 400 grams of particles based on SiO₂ (Sigma Aldrich) were produced following an identical procedure with the exception that the SiO₂ was used in place of the TiO₂. It was found that 5 grams of particles removed 100 mg of methyl orange from 1 liter of water in 5 minutes.

In a fifth demonstrated embodiment, the reactor of the first demonstrated embodiment is scaled up further, again maintaining the dimensional relationships between the various elements of the apparatus. The scaled up reactor has an overall height of 93.4 cm, a diameter of 70.1 cm, a radius of 35 cm and a volume of 180 liters. Thus, the height-diameter ratio remains 1.33. The disk impeller is also scaled, having a diameter of 32.1 cm. The disk impeller continues to have 8 indents symmetrically placed around the vertical axis of the disk impeller, however these indents are placed at a radial distance of 8.8 cm from the vertical axis of the disk impeller, the indents alternating up and down by 2.9 cm from the horizontal plane of the disk impeller. Each indent is 5.8 cm wide and 5.8 cm long. The scaled up collar has a height of 20.4 and is displaced 1.85 cm from the base of the reactor. The outside of the collar is 5.6 cm from the vertical reactor wall. The reactor is operated with the disk impeller rotating at a rate of 183 RPM, meaning that the energy transfer to the fluid remains constant with increased impeller size, in part because the tip speed of the disk impeller remains constant between the scaled versions. Utilizing a scaled up version of the process described with the first demonstrated embodiment, 2-6 kilograms of PCMA nanoparticles can be produced per batch.

As illustrated by the second through fifth demonstrated embodiments in comparison to the first embodiment, the disclosed apparatus and method can be successfully scaled to commercially viable levels. Testing of the resultant PCMA nanoparticles confirms that particle efficacy is not negatively affected by the scaling process.

One or more embodiments of the present disclosure have been described. Nevertheless, it will be understood that various modifications may be made without departing from the spirit and scope of the invention. Accordingly, other embodiments are within the scope of the following claims.

What is claimed is:

1. A method of making permanently confined micelle array nanoparticles, comprising the steps of:
providing a reactor with a reaction chamber and a high-shear mixing unit situated therein;
providing a set of reagents including a reaction solvent, an amount of prepared core-particles, an amount of ligand, an ammonia-water solution, and an amount of tetraethylorthosilicate;
adding to the reaction chamber and mixing the amount of prepared core-particles and the reaction solvent;
adding to the reaction chamber and mixing with the previously added reagents the amount of ligand;
adding to the reaction chamber and mixing with the previously added reagents the ammonia-water solution;
adding the amount of tetraethylorthosilicate to the reactor; and
operating said high-shear mixing unit so as to impart a volumetric energy input to a mixture of the reagents effective to maintain the core particles in a suspended state wherein the amount of ligand and the amount of tetraethylorthosilicate together bind to the core particles, thereby forming the permanently confined micelle array nanoparticles.

2. The method of claim 1, further comprising the steps of:
washing the permanently confined micelle array nanoparticles with an amount of ethanol at least once; and
drying the manufactured particles.

3. The method of claim 1 wherein said core particles are selected from the group consisting TiO₂, Fe₃O₄, SiO₂, SiO₂.X H₂O and Al₂O₃.

4. The method of claim 1 wherein said reaction solvent is a mixture of ethanol and deionized water.

5. The method of claim 1, wherein said ligand is 3-(trimethoxysily)propyl-octadecyldimethyl-ammonium chloride (TPODAC).

6. An apparatus for manufacturing permanently confined micelle array nanoparticles from an amount of core particles, an amount of ligand and another chemical, comprising:
a substantially cylindrical reactor including a vertical interior wall and a base, said wall having a bottom that is joined with said base, said reactor being configured to contain a fluid including said core particles and ligand;
a high shear mixing unit including a motor, a shaft joined with said motor at one end and extending into said reactor, and a disk impeller joined with said shaft at an end opposite said motor, said motor, shaft, and disk impeller each including a vertical axis that is coincidental with a vertical axis of said reactor;
a collar displaced between said vertical interior wall and said disk impeller;
a plurality of posts, each attached at a first end to said collar and attached at a second end to said vertical interior wall; and
wherein a geometry of said reactor, a geometry of said disk impeller, a geometry of said collar and a tip speed of said disk impeller are selected so that a volumetric energy input of said high shear mixing unit keeps said core particles suspended in said fluid while allowing said ligand and said other chemical to bond with said core particles thereby forming said permanently confined micelle array nanoparticles.

7. The apparatus of claim 6, wherein said disk impeller has a plurality of indented sections spaced at a radial distance from the vertical axis of the disk impeller and which alternate up and down.

8. The apparatus of claim 7 wherein said radial distance is equivalent to 54-55% of the distance between said vertical axis of said disk impeller and a edge of said disk impeller.

9. The apparatus of claim 7 wherein said indents each have a width and a length equivalent to 65-66% of a distance between said vertical axis of said reactor and said indents.

10. The apparatus of claim 7 wherein said indents alternate above or below said disk impeller by a distance equivalent to 49-51% of a length of one of said indents.

11. The apparatus of claim 1 wherein said geometry of said reactor is such that a ratio of a height of said reactor to a diameter of said reactor is 1.0-1.33.

12. The apparatus of claim 6 wherein said geometry of said disk impeller is such that said disk impeller has a radius equivalent to 45-46% of a distance between said vertical axis of said reactor and said interior wall.

13. The apparatus of claim 6 wherein said geometry of said collar is such that said collar is displaced between said interior wall and said disk impeller at the distance equivalent to 84-85% of a distance between said vertical axis of said reactor and said interior wall.

14. The apparatus of claim 6 wherein said geometry of said collar is such that said collar has a height equivalent to 68-69% of a radius of said collar.

15. The apparatus of claim 6 wherein said collar is displaced from said base of said reactor by a distance of 6-7% of a radius of the collar.

16. The apparatus of claim 1 wherein said disk impeller has an edge speed when operated of 0.3-0.4 m/sec.
